(19) United States
(12) Patent Application Publication
(10) Pub. No.: US 2008/0140500 A1
(43) Pub. Date: Jun. 12, 2008

(54) System and method of targeting and personalizing advertisements and generating advertising revenue

(76) Inventor: Uday Kurkure, Los Altos Hills, CA (US)

Correspondence Address: Uday Kurkure, 14197 Wild Plum Lane, Los Altos, CA, 94022, US

(21) Appl. No.: 11/062,118

(22) Filed: Feb. 19, 2005

(51) Int. Cl. G06Q 30/00

(52) U.S. Cl. 705/10; 705/14

(57) ABSTRACT

Systems and methods for advertising improve upon the prevalent methods of contextual and search-keyword advertising by analyzing documents that a user has selected to print. The system and methods incorporate a new technique of temporal advertising that uses the time of day at which print request is submitted. It also examines the user's location and the location of the printing device, as well as other factors to determine what type of ads would be of most interest and utility to the user at that time and place. Users can have highly targeted and personalized ads printed along with the primary printed material, for example, a travel itinerary or a ticket from a vendor. Thus, the user will conveniently have a “hardcopy” of a coupon or ad, in hand, that will likely be of interest to the user and be used to the benefit of the user and the advertiser.

### BACKGROUND OF THE INVENTION

1. Field of the Invention

The present invention relates generally to methods and systems for advertising. More specifically, it relates to targeting and personalizing advertisements for consumers and generating revenue by delivering the targeted and personalized advertisements being printed or displayed on a monitor.

2. Introduction

Prominent online companies such as Yahoo, Google and MSN target advertisements to a specific user based on what the user is reading on the Internet or on what the user is searching using keywords, referred to as keyword-based advertising. For example, Google's AdWord program auctions keywords such as “Hotels in San Francisco” to potential advertisers. Google's search engine uses keywords in a user's search query to target advertisements. When a user enters a search: “Hotels in San Francisco,” Google will display information on hotels in San Francisco from their database and the advertisers who bid the highest on the keywords “Hotels in San Francisco”. Advertisers bid on the keywords. When Google matches users' queries to “Hotels in San Francisco”, it displays the advertisements in the order of the bid price.

Many websites and portals like Yahoo and MSN display advertisements on their web pages. Any website interested in displaying advertisements and generating advertisement revenues can subscribe to Google's AdSense program. The AdSense program senses or detects the contents of the web pages displayed by a website and targets advertisements to those pages accordingly. These advertisements may or may not be selected by the user based on contents of the web pages. When the advertisements displayed are based on the contents of the web pages, the advertisements are called contextual advertisements. Google obtains a payment from the advertisers when a user clicks on an ad and shares this advertising revenue with the website owners who are AdSense network partners.

The most prevalent methods of advertising on paper do not target or personalize advertisements effectively. The vast majority of print advertisements are in newspapers and magazines. Of this type of ad, there is a small degree of targeted ads based on the regions or locations of the newspaper and the demographics of the readership. The advertisers pay the newspapers and magazines to publish advertisements. The placement of the advertisement in the newspaper or magazine is determined by the amount the advertiser pays for a particular placement. For example, is an advertisement on the front or cover page or the back page are more expensive than placement of the ad on less visible pages. Another medium of advertising is the direct mail advertisements. These are shipped in large volume and many are not read by those receiving them.

Two ways of determining a user's interest and thereby target advertisements to that user include examining keywords in a user search and determining what the user is reading on the Internet. However, it is being discovered that this is not an effective way of targeting advertisements. Users may read many pages on a website before they click or read the displayed advertisements that were targeted at them, if at all. Keyword-based advertisement methods display many advertisements that match the keywords, but the ads may nevertheless be irrelevant to the user's needs or interests. Furthermore, displays on many computing devices, such as hand-held devices and PDAs, and mobile phones have limited display area for advertisements. Screens are getting crowded with pop-up and sidebar advertisements. Finally, advertisements by Yahoo, Google and MSN displayed on computer monitors are not persistent. That is, when a user walks away from the computer, turns off the cell phone or PDA, or is outside the service region of a cell phone or Internet-enabled device, the user cannot view the advertisements.

Accordingly, there is a need for a system and method to determine a user's interests and needs. By doing so, ads can be more effectively targeted to a user and can remain persistent.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

A system and method to improve the state of the art in the field of advertising by determining a user's interests and needs for better targeting and personalizing of the advertisements to that user is described. Users browse many pages or search many keywords. Users generally print documents that are of interest to them or receive documents from third-parties that are of interest to them. Therefore, the system and method of the present invention determines the user's interest and needs by sensing what is being printed for the user. The topics and contents of the pages selected for printing, the time of the printing, the location of the printer, the location of the user, the profile of the user and the location of the computer, among other factors, are taken into consideration when determining which advertisements will displayed on a computer screen or will be printed. A computer program of the present invention analyzes documents selected for printing. The program may be embedded in a computer, a printer, a mobile or hand-held computing device, a cell phone, or a digital camera.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1. is a diagram of a network of computers, printers and an ad server controlled by a service provider in accordance with one embodiment of the present invention.

FIG. 2 is an illustration of a printed page showing content without advertisements and a printed page showing the same content with targeted advertisements in accordance with one embodiment of the present invention.

FIG. 3 is a flowchart of basic steps of a process of one embodiment of the present invention.

FIG. 4 is a flowchart of one stage in the process of generating revenues from serving advertisements in accordance with one embodiment of the present invention.

FIG. 5 is a flowchart of another stage in the process of generating revenues from serving advertisements in accordance with one embodiment of the present invention.

FIG. 6 is a flowchart of a final stage in a process of generating revenues from serving advertisements in accordance with one embodiment of the present invention.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Methods and systems to determine one or more areas of interest or of potential interest to a user and for printing or displaying advertisements that are relevant to that user's interests or needs are described in the various figures. Content that a user has decided to print is analyzed to determine the user's interests or needs. The entity that serves the advertisements from a database of advertisers is referred to as the ad service provider or, simply, service provider. The service provider creates and distributes a print-content sensor program, described below. The ad service provider also controls the database of ads and all relevant servers and computer networking equipment for implementing the ad serving system of the present invention.

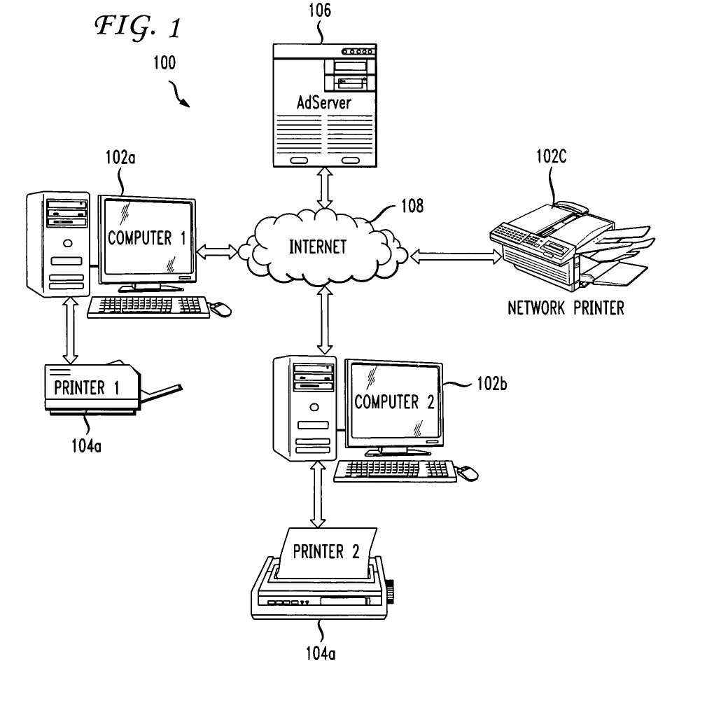

FIG. 1 is a diagram of a network 100 of computers 102a, 102b, 102c, printers 104a, 104b, and an ad server 106 controlled by the service provider, all of which are connected by the Internet 108. In a described embodiment of the present invention one or more computers have a print-content sensor program provided by the service provider. These computers are connected to the ad server via the Internet. The computers may be connected to printers using conventional networking protocols and methods. The printers themselves may have the print-content sensor program embedded in them. In some cases a customized or specialized computing device or Internet-enabled device may have a printer attached as part of the device, such as hand-held parking garage ticket dispensers or similar devices used at hotels and car rental agencies.

The print-content sensor program scans content that a user has decided to print and thereby determines potential user interests or the interests of a party for whom the user is printing the content. For example, when a user has decided to print a travel itinerary, the print-content sensor program scans the document to detect city names and dates of travel. Based on this, it will print relevant advertisements relating to hotels, rental cars at the relevant locations, coupons for restaurants in the relevant cities, and so on, along with the itinerary.

Another scenario occurs when a user has decided to print a coupon. The system of the present invention, specifically the print-content sensor program, scans the content, i.e., the coupon, being printed. The system determines whether it can provide the user with a relevant, more competitive coupon and deliver the coupon to the user's computer or to the user's printer, or both. In another scenario, a user prints birthday party invitations at a local print shop. The service provider system of the present invention is able to scan the print jobs and print, on separate sheets, coupons for party supplies and other relevant, targeted ads. Similarly, if real estate purchase documents are being printed at a local printer, the system can print ads for local handymen, furniture stores, and so on. In yet another scenario, when a ticket is printed at a gas station, a coupon for a nearby merchant or business is printed along with the ticket. The coupon can be suitable depending on the time of day. For example, if the ticket is printed at noon, a coupon for a local restaurant may be printed or if at night, a coupon for a movie ticket. In yet another scenario, when a small business prints invoices, the business can include with the invoice relevant ads based on the services or goods provided by the small business. By doing so, the small business can generate advertisement revenue. This process is described in greater detail below.

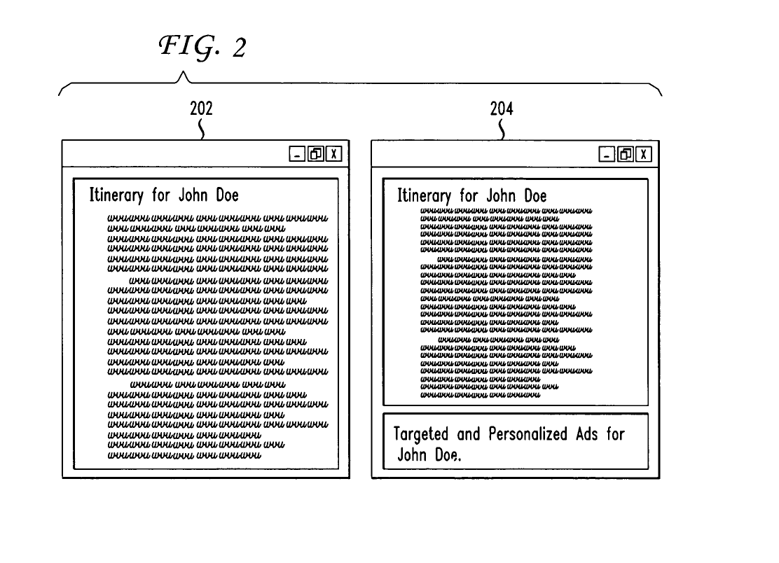

FIG. 2 shows an example of a printed page with and without targeted advertisements. On a page where only the content, such as an itinerary for John Doe, is printed, the entire page 202 contains the content. In 204 the itinerary content is scaled down so there is space on the same page for ads targeted to John Doe based on the content of the itinerary. The user has access to these personalized and targeted advertisements even when he does not have an access to a computer or any Internet-enabled device with a screen. Thus, so long as the user carries a printed itinerary, the user has the targeted ads with him. This makes the advertisements mobile, easily accessible, and persistent.

The print-content sensor program has knowledge of a user by virtue of residing on the user's computing device or the user's printer. The program knows the user profile, user location, computer location, and printer location, and uses this data in determining potential user interests and needs. In a described embodiment, the printer, computer location/addresses are defined by building number, street name, city, state, zip code, country and IP address. The user profile may have a birth date, gender, permanent address, current address, email address, hobbies, current interests, frequent travel destinations, and so on. When the sensor program is installed, the user profile, user location, computer location, printer location is queried and stored. The program can scan many different document formats including Microsoft WORD, XML, HTML, PDF, POSTSCRIPT, PCL, and RTF.

The program can also store user preferences with respect to advertisement layout on printed pages. It can print the ads on the same page as the itinerary, the reverse side of the pages, or on new pages appended to the itinerary. The advertisement layout preference is configurable anytime. In addition, the user has the option of overriding a certain configuration, such as ad layout, at print time. Users may scale down the size of the primary printed content to create space for the targeted advertisements. Users may also select to not have any advertisements printed or display the advertisements on a monitor instead of having them printed. The users may are also given the option to select which coupons and ads he wants printed by viewing them on the screen first.

In another embodiment, the sensor program is installed in a standalone-networked printers. The documents printed on these printers are typically not for individual use but rather are for printing documents that will be distributed. Examples of such printers are printers that dispense tickets at parking garages or that print train tickets, and so on. For example, the system prints targeted advertisements for local merchants on the parking garage tickets.

The system also takes into account the time at which the print request is made. Referred to as temporal advertising, this enables advertisements selected by the system for a particular user to depend on the time the user submits print request. For example, when someone is printing a map and travel directions to a certain destination in the early morning, the system may print coupons for local restaurants at that destination serving breakfast or lunch. If a user is printing the same in the evening, the system may print ads or coupons for nightlife or evening venues.

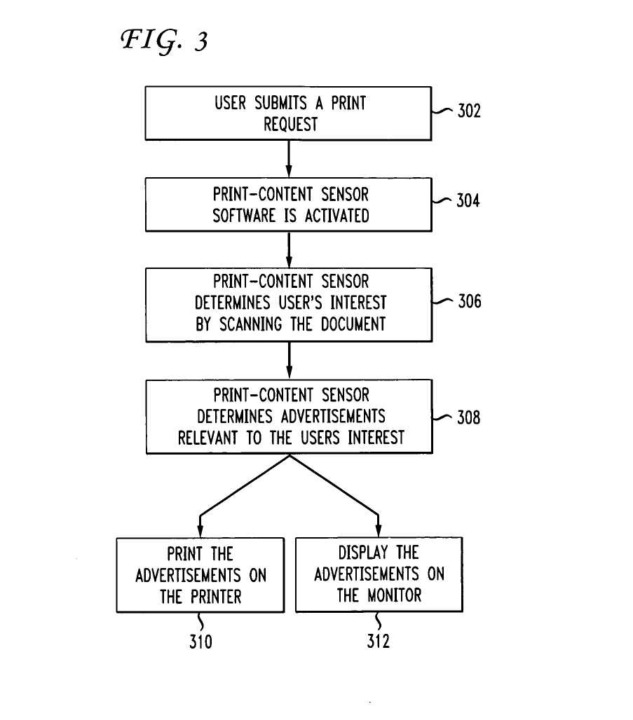

FIG. 3 is a flowchart of basic steps of a process of one embodiment of the present invention. At step 302 a user submits a print request. The user can be printing to a network printer, a private/home printer, or to a printer in a hand-held device or stand-alone machine. The print request can be a request to print any type of content ranging from simple tickets to elaborate documents. At step 304 the print-content sensor program is activated. The program may reside on the computer, in the printer, in a stand-alone device, such as a ticket or ticket dispensing machine, a hand-held device, and so on. At step 306 the program scans the content being printed. Upon scanning the content and examining other factors such as location, time, user profile, and other attributes, the program determines possible interests and needs based on the content of what is being printed and the factors mentioned. At step 308 the program and ad serving system determine which ads should be provided based on the interests and needs determined at step 306. At step 310 the ads are sent to a printer and printed along with the original content and at step 312 the system sends the ads to be displayed on the monitor.

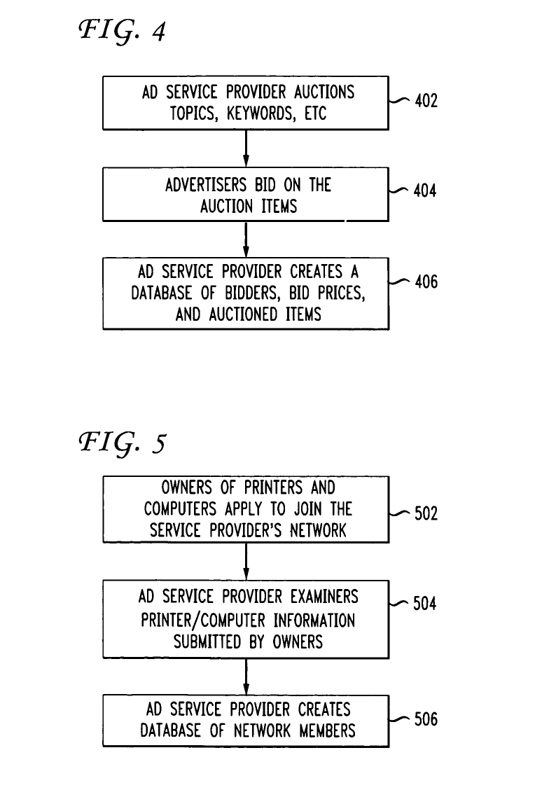

FIG. 4 is a flowchart of one stage in the process of generating revenues from serving advertisements in accordance with one embodiment of the present invention. At step 402, the system auctions topics, keywords, neighborhoods defined by a location and distance, neighborhoods defined by postal zip code, and time slots. At step 404, interested advertisers bid on the auction items. The bidding features of the system allow bidding on topics, keywords, neighborhoods defined by address, distance or zip code and time or any combination of the attributes. For example, the keywords “Hotels in San Francisco” can be an auction item. “Tourism in San Francisco” is a topic that can be auctioned. At step 406, the auction system creates a database of bidders/bid prices and auctioned items.

FIG. 5 is a flowchart of another stage in the process of generating revenues from serving advertisements in accordance with one embodiment of the present invention. Independent of the steps 402 to 406, owners of printers and computers apply to become partners in the service provider's network at step 502. During the application process, the owners submit information about themselves and their printers and computers. The printer information consists of make and model, location of the printer, internet address of the printer, color capability, and so on. Computer information consists of computer make, model, monitor make and model, and network address. The applicants/owners also need to submit information about the usage of the printers and computers. This information determines if the printer/computer is used for personal or business activity.

At step 504 the system examines printers, computers. and their owners' information. If the owner uses the printer/computer for business activity, the owner is classified as a distributor and becomes eligible for revenue sharing. Distributors are members of the service provider's network.

At step 506 the system creates a database of its members, their printers and computers. The database contains information about the printer owners, the printer's physical location, printer make and model, printer's color capabilities, duplex printing capabilities, computer owners, computer model and make, and internet address. The database also contains information on an owner's preferences regarding type of advertisements. The database is network accessible and searchable based on any of the fields in the entry record.

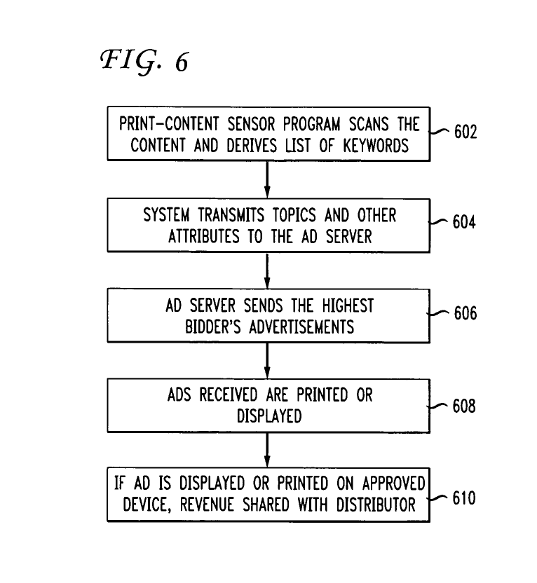

FIG. 6 is a flowchart of a final stage in a process of generating revenues from serving advertisements in accordance with one embodiment of the present invention. At step 602 the print-content sensor program scans the content to be printed and derives a list of keywords, topics, etc. The program and system matches the keywords and topics in a printed page to targeted advertisements that have the highest bid price and that has the maximal match with the attributes specified by the advertiser. Consider an example of a travel itinerary being printed or displayed. The methods in the print-content sensor program determine the topic of the document to be “itinerary.” It then determines that the destination is San Francisco and thereby decides that the relevant advertisements for this page are those related to tourism in San Francisco. At step 604 the system send the topics, keywords, time slots or any of the attributes to the ad server. In this example, the system sends the topic “Tourism in San Francisco” to the ad server. At step 606, the ad server sends back the highest bidders' advertisements for the topic or any of the previously mentioned attributes. In this example, it will send advertisements related to tourism in San Francisco. More than one advertisement may be sent. At step 608 the advertisements received are printed or displayed.

When an advertisement is printed on one or more pages or displayed on a computer screen, the advertiser will pay the bid amount to the service provider. At step 610 it is determined whether the advertisement is displayed or printed on an approved distributor's printer or display and the advertising revenue is shared with the previously approved distributor.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

1.-3. (canceled)

4. A method of advertising comprising:
receiving a signal indicating that a command has been sent by a user to print content at a printing device;
scanning the content at one of the following times:
a) before the content is printed,
b) while the content is printing, and
c) after the content has been printed;
determining one or more interests of the user upon scanning the content;
identifying one or more advertisements relating to the one or more interests; and
printing the one or more advertisements with the content in a printed medium whereby the user has the one or more advertisements with the content in the printed medium.

5. A method as recited in claim 4 wherein identifying one or more advertisements further comprises using the time the content is printed to determine the one or more advertisements.

6. A method as recited in claim 4 wherein identifying one or more advertisements further comprises using the date the content is printed to determine the one or more advertisements.

7. A method as recited in claim 4 further comprising using a history of data gathered from previous printed content that was printed by the user to further identify the one or more advertisements.

8. A method as recited in claim 4 further comprising using a locality of the printing device to identify the one or more advertisements.

9. A method as recited in claim 4 further comprising examining an advertisement and determining whether there is a more competitive advertisement that can be provided to the user.

10. A method as recited in claim 4 further comprising selecting an advertisement according to a user profile.

11. A method as recited in claim 4 wherein printing an advertisement further comprises providing the user with options on how the advertisement is presented with the content.

12. A method as recited in claim 4 further comprising displaying the one or more advertisements on a computing device thereby enabling a user to select an advertisement to be printed.

13. A method of advertising comprising:
scanning a document that is intended to be printed by a user thereby examining content of the document;
determining one or more interests of the user based on the content of the document;
determining a time of the print request;
selecting an advertisement according to the one or more interests of the user and the time of the print request; and
printing the advertisement with the document, wherein the advertisement is targeted to and personalized for the user.

14. A method as recited in claim 13 wherein a document is scanned while it is being printed.

15. A method as recited in claim 13 wherein a document is scanned after the document has been printed.

16. A method as recited in claim 13 further comprising:
determining a location of the print request; and selecting an advertisement according to one of a location of the printing device, a location of the user, and a location of the printing device and the user.

17. A method as recited in claim 13 further comprising selecting an advertisement according to a user profile.

18. A method as recited in claim 13 wherein selecting an advertisement further comprises utilizing knowledge of a computing device being used by the user and a printer device.

19. A method as recited in claim 13 wherein printing the advertisement with the document further comprises providing the user with options on how the advertisement is presented with the content in a printed medium.

20. A method as recited in claim 19 wherein the options include: scaling down the content so that the advertisement can be contained on the same page as the content.

21. A method as recited in claim 13 further comprising displaying one or more advertisements on the computing devices thereby enabling a user to select an advertisement to be printed.

22. A method as recited in claim 13 further comprising examining a selected advertisement and determining whether there is a more competitive advertisement that can be provided to the user.

23. A method of advertising to a customer, the method comprising:
receiving a signal indicating that a command has been sent to print content at a printing device;
scanning the content at one of the following times (i) before the content is printed, (ii) while the content is printing, and (iii) after the content has been printed;
examining a print time wherein the print time is the time at which the content is being printed;
identifying one or more advertisements based on the print time;
displaying the one or more advertisements to the customer on a monitor allowing the customer to select an advertisement to be printed; and
providing the one or more advertisements with the content in a printed medium such that the one or more advertisements can be viewed on the printed medium with the content.

24. A method as recited in claim 23 further comprising determining one or more interests of the customer upon scanning the content.

25. A method as recited in claim 24 wherein identifying one or more advertisements further comprises examining the one or more interests determined from scanning the content.

26. A method of generating revenue from distributing an advertisement, the method comprising:
auctioning a plurality of keywords to one or more advertisers;
creating an auction database of bidders and auctioned keywords;
creating a network-member database containing data on owners of printers and computers and data on the computer and printer devices;
transmitting auctioned keywords to an advertisement server;
receiving advertisements from a plurality of highest bidders wherein each bidder has made a payment;
if an advertisement is displayed or printed on an approved device, then sharing payment with a distributor.

27. A system for advertising comprising:
a module configured to receive a signal indicating that a command has been sent by a user to print content at a printing device;
a scanning module for scanning the content at one of the following times:
a) before the content is printed,
b) while the content is printing, and
c) after the content has been printed;
a module configured for determining one or more interests of the user upon scanning the content; and
a module for identifying one or more advertisements relating to the one or more interests.

28. A system for advertising comprising:
a module for scanning and examining a document that is intended to be printed by a user;
a module for determining one or more interests of the user based on the content of the document;
a module for determining a time of the print request;
a module for determining a location of a printing device;
a module for determining a location of the user; and
a module for selecting an advertisement according to the one or more interests of the user, the time of the print request, the location of the print device, and the location of the user.

29. A system for advertising to a customer, the system comprising:
a module for receiving a signal indicating that a command has been sent to print content at a printing device;
a module for scanning the content at one of the following times (i) before the content is printed, (ii) while the content is printing, and (iii) after the content has been printed;
a module for examining a print time wherein the print time is the time at which the content is being printed;
a module for identifying one or more advertisements based on the print time;
a module for displaying the one or more advertisements to the customer on a monitor allowing the customer to select an advertisement to be printed.

30. A system for advertising comprising:
means for receiving a signal indicating that a command has been sent by a user to print content at a printing device;
means for scanning the content at one of the following times:
a) before the content is printed,
b) while the content is printing, and
c) after the content has been printed;
means for determining one or more interests of the user upon scanning the content; and
means for identifying one or more advertisements relating to the one or more interests.

31. A system for advertising comprising:
means for scanning and examining a document that is intended to be printed by a user;
means for determining one or more interests of the user based on the content of the document;
means for determining a time of the print request;
means for selecting an advertisement according to the one or more interests of the user and the time of the print request.

32. A system for advertising to a customer, the system comprising:
means for receiving a signal indicating that a command has been sent to print content at a printing device;
means for scanning the content at one of the following times (i) before the content is printed, (ii) while the content is printing, and (iii) after the content has been printed;
means for examining a print time;
means for identifying one or more advertisements based on the print time;
means for displaying the one or more advertisements to the customer on a monitor.
